(19) United States
(12) Patent Application Publication
(10) Pub. No.: US 2014/0188577 A1
(43) Pub. Date: Jul. 3, 2014

(54) AUTOMATED BILLING SYSTEM

(71) Applicant: Jonathan L. Gerber, Los Angeles, CA (US)

(72) Inventor: Jonathan L. Gerber, Los Angeles, CA (US)

(21) Appl. No.: 13/733,051

(22) Filed: Jan. 2, 2013

(51) Int. Cl. G06Q 10/10; G06Q 10/06

(52) U.S. Cl. CPC G06Q 10/1091; G06Q 10/06398
USPC 705/7.42; 705/32

(57) ABSTRACT

The present invention is an automated billing system that streams data from an employee's computer screen to a remote server and analyzes the data to determine the type of activities being performed on the employee's computer. The remote server will utilize various tools and functions (e.g., machine learning, text recognition, and computer vision) to determine the type of activity is being performed and attribute the activity to an appropriate client and assigning an appropriate billing code to the activity. The automated billing system will also broadly describe the activity being performed in a few sentences and track the time spent working on each event by the employee. In situations where memos or emails are being drafted, the automated billing system will summarize the correspondence and add the correspondence as a record to a database.

### FIELD OF THE INVENTION

This invention generally relates to systems and methods for automated processing of billing information. In particular, the invention relates to systems and methods for automatically extracting data from an employee's computer screen to a remote server and interpreting the data to determine the type of activities being performed in order to process billing information.

### BACKGROUND OF THE INVENTION

Most businesses generally manually process and generate client invoices on a regular basis. This process is often time consuming, as it typically requires the employee to log his or her time spent on a timesheet and accurately record the period of time spent for each activity. Once the timesheet is filled out, it is typically sent to the appropriate personnel for review and approval, which is later processed for billing to the respective client.

Unfortunately, most conventional billing systems are subject to many administrative problems. For example, when the employee manually records his or her time in the timesheet, the employee's manager typically lacks supervision and control with the data inputted into the timesheet. Each work-related activity may not be accurately logged or billed, and some billing software may require sufficient computer knowledge for manually inputting billing information.

Regarding telephone calls, accounting for caller activities also usually remain problematic. Phone calls made or received on behalf of a client may be inaccurately billed, as the professional may forget to administratively log, bill, and/or record the actual amount of time spent on the phone call. This is further caused by the common practice of logging call time in preset increments of an hour, such as a sixth of an hour, and the client may also be overcharged for the actual professional time being spent.

Therefore, what is needed is a billing system that provides accurate and effective recording of time spent for each activity. Because the method of recording timesheets may depend upon the particular profession, it is desirable that the billing system accurately accounts for and automatically bills a client as function of time spent on a particular matter.

### SUMMARY OF THE INVENTION

To minimize the limitations in the prior art, and to minimize other limitations that will become apparent upon reading and understanding the present specification, the present invention discloses an automated billing system and method that automatically extracts data from an employee's computer screen to process billing information. The stream of content on the screen is preferably sent to a remote computer or server. The remote computer or server uses machine learning, text recognition, and computer vision to determine what activity is being performed, attribute that task to an appropriate client, assign an appropriate billing code, and describe broadly the activity being performed. The automated billing system will also track time spent on each event. When emails or memos are being drafted on the screen, the invention preferably uses an auto summary functionality to summarize the correspondence and add that summary to the database record.

One embodiment of the present invention is an automated billing system, the system comprising: one or more electronic data processing units; one or more software applications; and a server; wherein the one or more electronic data processing units are configured for one or more work-related activities and are used by at least one employee; wherein the one or more software applications are installed in the one or more electronic data processing units and are configured to capture a plurality of data from the one or more electronic data processing units; wherein the one or more software applications transmits the plurality of data to the server; wherein the server analyzes the plurality of data to calculate a plurality of billing information; wherein the server generates a timesheet; and wherein the timesheet is based upon the plurality of billing information. The one or more electronic data processing units may be comprised of one or more display screens; wherein the plurality of data may be a plurality of screen data from the one or more display screens of the one or more electronic data processing units. The server may analyze the plurality of data by utilizing one or more machine learning algorithms, one or more text recognition methods, and one or more computer vision algorithms. The plurality of billing information may be selected from the group of information consisting of: a client matter; a work code; and a description of the one or more work-related activities. The server may be configured to provide: an alert; and a productivity report; wherein the alert is sent to a manager and the at least one employee when the at least one employee performs one or more improper activities; and wherein the productivity report is a graphical representation of a work performance of the at least one employee. The server may provide one or more invoicing templates based upon the timesheet. The server may automatically send one or more invoices to one or more clients. The server may verify the one or more work-related activities when the server analyzes an engagement letter of the one or more clients. The one or more electronic data processing units may be one or more mobile phones, such that the plurality of data is one or more caller information; and wherein the one or more caller information is comprised of: one or more telephone numbers; one or more time stamps; and a time period. The one or more mobile phones may be comprised of one or more display screens; wherein the plurality of data is a plurality of screen data from the one or more display screens of the one or more mobile phones.

Another embodiment of the present invention is a computer-based method for automated billing, the method comprising: providing one or more electronic data processing units; providing one or more software applications; providing a server; wherein the one or more electronic data processing units are configured for one or more work-related activities; wherein the one or more software applications are installed in the one or more electronic data processing units and are configured to capture a plurality of data from the one or more electronic data processing units; using the one or more electronic data processing units by at least one employee to perform the one or more work-related activities, such that the plurality of data is generated; capturing the generated plurality of data from the one or more electronic data processing units by the one or more software applications; transmitting the plurality of generated and captured data to the server by the one or more software applications; analyzing the plurality of generated, captured, and transmitted data by the server to calculate one or more billing information; and providing a timesheet by the server; wherein the timesheet is based upon the one or more billing information. The one or more electronic data processing units may be comprised of one or more display screens; wherein the plurality of data may be a plurality of display screen data of the one or more electronic data processing units. The analyzing by the server may be performed by the server via one or more machine learning algorithms, one or more text recognition methods, and one or more computer vision algorithms. The one or more billing information may be selected from the group of information consisting of: a client matter; a work code; and a description of the one or more work-related activities. The computer-based method for automated billing may further comprise the steps of: issuing an alert by the server; and issuing a productivity report by the server; wherein the alert is sent to a manager and the at least one employee when the at least one employee performs one or more improper activities; and wherein the productivity report is a graphical representation of a work performance of the at least one employee. The computer-based method may further comprise the step of: providing by the server one or more invoicing templates for the timesheet. The computer-based method for automated billing may further comprise the step of: sending by the server one or more invoices to one or more clients. The computer-based method for automated billing may further comprise the step of: verifying by the server the one or more work-related activities when the server analyzes an engagement letter of the one or more clients. The one or more electronic data processing units may be one or more mobile phones, such that the plurality of data is one or more caller information; wherein the one or more caller information may be comprised of: one or more telephone numbers; one or more time stamps; and a time period; and wherein the plurality of data may be comprised of a display screen activity of the one or more mobile phones. The one or more work-related activities may be related to drafting an email; wherein the server summarizes the email.

It is an object of the present invention to provide an automated billing system that automatically processes billing information by extracting data from an employee's computer screen to a server and interpreting the data to determine the type of activities being performed in order to process billing information.

It is an object of the present invention to provide an automated billing system that accurately captures billable time, identifies inefficiencies within the office, reduces billing inquiries and disputes, and improves collection cycles by enabling more timely delivery of invoices. The automated billing system preferably reduces workload of the billing staff, ensures engagement letters are appropriate for the work being done, is intuitive (i.e., zero training), and may bill telephone conversations. Additionally, the automated billing system is preferably system agnostic, such that it allows users to work with any computer regardless of the software, hardware, or operating system used.

It is an object of the present invention to provide an automated billing system that may be used by any legal accounting, consulting, or other professional firm that bills hourly.

It is an object of the present invention to provide an automated billing system that preferably interprets employee activity displayed in a computer screen and translates such activity into a timesheet regardless of the type of software being used.

It is an object of the present invention to provide an automated billing system that records data and/or caller activity regardless of the phone being used. Preferably the automated billing system will take the data and present it to the billing professional to code. Preferably, the automated billing system will learn how each telephone number is to be billed and determine if there are any inconsistencies, such that the caller activity is work related.

It is an object of the present invention to provide an automated billing system that bills accurately to the sixth decimal.

It is an object of the present invention to provide an automated billing system with machine learning functions, such that the system may be able to differentiate the work activity with the corresponding client.

It is an object of the present invention to provide on-the-fly reports to illustrate a worker's productivity.

It is an object of the present invention to detect activity that is incorrectly billed or should not be billed.

It is an object of the present invention to provide a timesheet and invoice, which are both generated quickly and performed online, streamlined, and automated.

It is an object of the present invention to provide one or more invoicing templates, which may be assigned to one or more clients and which may be changed on-the-fly.

It is an object of the present invention to deliver bills and invoices electronically or by physical letters. The invoices will contain details of each work related activity and may provide the option to pay automatically where an electronic invoice is sent. Regarding physical invoices, a fully-customized envelope may be used, depending upon the type of client. The invoices may also include one or more out-of-pocket expenses such as printing expenses, delivery expenses, and the like.

It is an object of the present invention to provide notification to the professional when a client is behind on his or her payment.

It is an object of the present invention to determine whether work activity is performed outside the scope of the engagement letter by reviewing the activity with the engagement letter.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the automated billing system and shows the process flow of the automated billing system.

FIG. 2 is a timesheet of one embodiment of the automated billing system.

FIG. 3 is an invoice of one embodiment of the automated billing system.

FIG. 4 is a flow chart of one embodiment of the automated billing system and shows the process of managerial reporting.

FIG. 5 is a block diagram of one embodiment of the computer-based method for automated billing.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the graphs, figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “computer” and “electronic data processing unit” refer to any device that processes information with an integrated circuit chip, including without limitation, mainframe computers, work stations, servers, desktop computers, portable computers, laptop computers, telephones, smartphones, embedded computers, wireless devices including cellular phones, tablet computers, personal digital assistants, digital media players, portable game players, and hand-held computers; “internet” refers to any collection of networks using standard protocols, whether Ethernet, ATM, FDDI, WI-FI, Token ring, or any combination thereof.

The term “employee” generally refers to any person or entity employed for wages or salary, including without limitation, lawyers, accountants, consultants, independent contractors, professionals, and the like. The term “client” is preferably a person or entity that uses the services of a professional person, employee, or company in return for payment based on hourly services.

The term “work-related activities” generally refer to any activity or task relating to an employee while at work, including without limitation, word processing, drafting documentation, computer-aided drafting, mathematical problem solving, software development such as software coding, engineering design, generating presentation slides, video and audio conferencing (e.g., webinars), data input such as inputting spreadsheet files, preparing, reading and/or sending electronic mail messages, note-taking, drafting/editing publications, marketing, web design, troubleshooting, consulting, diagramming workflow or block diagrams, transferring files, and project management.

The term “machine learning algorithm” generally refers to one or more algorithms that take input empirical data and produces patterns or predictions thought to be features of the underlying activities that generated the data for billable information purposes, including without limitation, averaged one-dependence estimators (AODE), artificial neural network, backpropagation, Bayesian statistics, Naive Bayes classifier, Bayesian network, Bayesian knowledge base, case-based reasoning, decision trees, inductive logic programming, Gaussian process regression, gene expression programming, group method of data handling (GMDH), Learning Automata, Learning Vector Quantization, minimum message length (e.g., decision trees, decision graphs, etc.), lazy learning, instance-based learning, Nearest Neighbor Algorithm, analogical modeling, probably approximately correct learning (PAC) learning, ripple down rules, a knowledge acquisition methodology, symbolic machine learning algorithms, subsymbolic machine learning algorithms, support vector machines, Random Forests, ensembles of classifiers, bootstrap aggregating (bagging), boosting (meta-algorithm), ordinal classification, regression analysis, information fuzzy networks (IFN), Linear classifiers (e.g., Fisher's linear discriminant, logistic regression, Naive Bayes classifier, perceptron, support vector machines), quadratic classifiers, k-nearest neighbor, boosting, decision trees (e.g., C4.5, random forests), Hidden Markov models, artificial neural network, data clustering, expectation-maximization algorithm, self-organizing map, radial basis function network, Vector Quantization, Generative topographic map, Information bottleneck method, IBSEAD, Apriori algorithm, Eclat algorithm, FP-growth algorithm, Single-linkage clustering, conceptual clustering, K-means algorithm, fuzzy clustering, temporal difference learning, Q-learning, Learning Automata, and Data Pre-processing. The machine learning algorithms are typically initially setup by the billing administrator or information technology personnel and may require identifying the most common work codes used in the company.

The term “computer vision algorithms” refers to methods for acquiring, processing, analyzing, and understanding images and, in general, high-dimensional data from the real world in order to produce numerical or symbolic information, including without limitation, image acquisition, pre-processing, feature extraction, detection/segmentation, high-level processing (e.g., image recognition, image registration), and decision-making.

The present invention is preferably an automated billing system that analyzes data from an employee's electronic data processing unit in order to accurately provide billing information. Specifically, the present invention preferably streams data from an employee's computer screen to a server and analyzes the data in order to determine billing information. The electronic data processing unit will preferably utilize various functions such as machine learning, text recognition, and computer vision to identify the type of activities being performed. Additionally, the electronic data processing unit will preferably attribute the activity to an appropriate client while assigning an appropriate billing code. The electronic data processing unit may broadly describe the activity being performed in a few sentences and track the time spent on each event. In situations where memos or emails are being drafted, the automated billing system may also summarize the correspondence and add the correspondence as a record to a database.

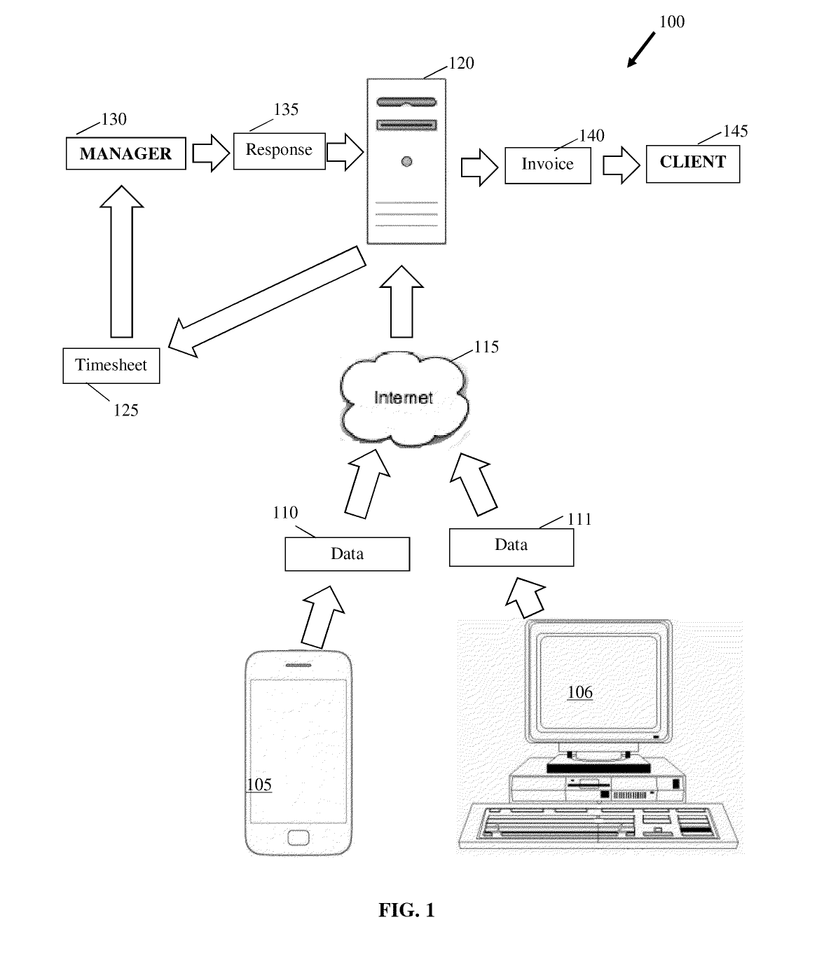

FIG. 1 is a flow chart of one embodiment of the automated billing system and shows the process flow of the automated billing system. As shown in FIG. 1, one embodiment of the automated billing system 100 preferably includes: one or more electronic data processing units 105, 106; data 110, 111; Internet 115; server 120; timesheet 125; manager 130; response 135; invoice 140; and client 145. The electronic data processing unit 105, 106 is preferably a computer device configured to be used by one or more employees for work-related activities (e.g., desktop personal computer or laptop computer). Additionally, the electronic data processing unit preferably includes at least one display screen for displaying video screen data, which is typically any visual video stream that displays an employee's computer desktop, wallpaper, and/or one or more applications when performing one or more functions. Although FIG. 1 shows a smartphone or mobile phone device 105 and a desktop computer 106 as electronic data processing units, it should be understood that any type of computing device may be used such as a tablet computer, laptop computer, notebook computer, and server console. The electronic data processing unit 105, 106 preferably includes one or more software applications, which are preferably configured to extract data 110, 111 from the electronic data processing unit 105, 106 and transmit the data 110, 111 to the Internet 115 and ultimately to the server 120. The Internet 115 is preferably any electronic communications network that interconnects computer networks and organizational computer facilities around the world, including computers interconnected within the same region or location. The server 120 is preferably a hardware configuration with a central processing unit that is configured to analyze data 110, 111 sent by the electronic data processing units 105, 106. Additionally, the server 120 is preferably configured to create billing information in order to generate a timesheet 125 that will be sent to the manager 130. The manager 130 is preferably a person or entity who is responsible for controlling, supervising, or administering all or part of a company by overlooking one or more employees and preferably reviews, edits, and/or approves the timesheet 125. In other embodiments, the timesheet may go to the employee, or both the manager and the employee. A response 135 is typically any approval, comments, or edits sent from the manager 130 to the server 120. An invoice 140 is preferably an itemized bill or detailed list of the services rendered by the company or professional with an account of all costs and/or out-of-pocket expenses. The client 145 is preferably a person or entity that is seeking the services of a professional person, employee, or company in return for payment based on the services, hourly or flat fee.

FIG. 1 also shows the process flow of the automated billing system 100. Preferably, the employee performs one or more functions on the electronic data processing unit 105, 106. While working on an activity, one or more software applications installed on the electronic data processing units 105, 106, preferably captures data 110, 111 from the electronic data processing unit 105, 106 and transmit the data 110, 111 to the Internet 115 and ultimately to the server 120. For example, a software application for electronic data processing unit 106 may capture data 111 such as a video stream displayed on the monitor of a computer desktop and sends the data 111 to the server 120. Although FIG. 1 shows the plurality of data 110, 111 being sent through the Internet, the data 110, 111 may be sent via any intranet, wired or wireless mechanism. Because the software applications are preferably capturing visual contents of a display screen, rather than interfacing with specific computer desktop applications, the automated billing system 100 is preferably software, hardware, and operating system agnostic—i.e., the electronic data processing units of the automated billing system 100 are not dependent upon software and hardware compatibility. The software applications may also include a disable function to suppress the screen-capture technology for privacy concerns, as determined by administrators. After the server receives the data 110, 111, the server 120 then preferably performs one or more analytical functions such as machine learning algorithms, text recognition methods, or computer vision algorithms to analyze and interpret the data 110, 111. For example, the server 120 preferably uses computer vision algorithms to acquire, process, and analyze the images from the video stream data 110, 111, and employs text recognition methods such as optical character recognition (OCR) to convert the video and images into machine-encoded text. Once the server 120 has the machine-encoded text, the server 120 may utilize machine learning algorithms to determine billing information, including without limitation, the type of activities, which the employee may be performing and the length of time spent on each activity. The billing information is then used by the server 120 to automatically generate a timesheet 125, which typically provides information to the manager 130 such as the date, client matter, work code, description of the type of work being performed, and the amount of time spent for each activity. The automated billing system 100 may initially need to be trained to analyze and differentiate such information, but will later be able to recognize such information in an automatic fashion. Once the manager 130 receives the timesheet 125, the manager 130 preferably reviews and edits the timesheet 125. The manager 130 then may send the server 120 a response 135, which may be an approval, comments, edits, or a combination thereof. Once the server 120 receives the response, the server 120 may process the response 135 from the manager 130 and send an invoice 140 to the client 145. Although FIG. 1 shows the manager 130 sending a response 135 to the server, it should be understood that the manager 130 may process the timesheet 125 to create an invoice and directly send the invoice to the client 145. It should also be understood that the system 100 may generate an invoice without having the manager review the timesheet. Preferably, where memos or emails are being drafted by the manager 130 or employee, the automated billing system will summarize the contact information in the memo or email and add the contact information as a record to a database.

Regarding call activities, FIG. 1 also shows the process flow for caller activity. Specifically, one or more software applications in a smartphone, for instance, will preferably be configured to transfer data 110 such as telephone numbers, time stamps, and the time period for each caller activity. It should be understood that this system may also work with desktop landline phones. This may be achieved by utilizing various telephony standards such as station messaging detail record (SMDR) and/or telephony application programming interface (TAPI). SMDR, for instance, utilize various data content during a telephone call such as time, date, call duration, telephone number dialed, caller identification, extension, line/trunk location, cost, and call completion status. Additionally, TAPI, which is a Microsoft® Windows® application programming interface, may provide computer telephony integration, which may be used to gather the telephone calls, time stamp, and the time period of each caller activity. By gathering such caller information, the automated billing system 100 preferably integrates such information into the timesheet 125. Preferably, the automated billing system 100 will be capable of learning how each telephone number is billed and inquire if there are any inconsistencies. Moreover, the automated billing system 100 may be configured to capture display screen activity, similar to the data 111 transmitted from desktop and laptop computers, as discussed above. This will be used to increase the server's accuracy in calculating billing information made/received from the electronic data processing unit 105. Furthermore, the automated billing system 100 may consider the time-of-day when performing billing calculations to determine the multiple roles an employee or professional may have with a particular party (e.g., calls made during the evening are likely considered personal, whereas calls made during the day are likely billable).

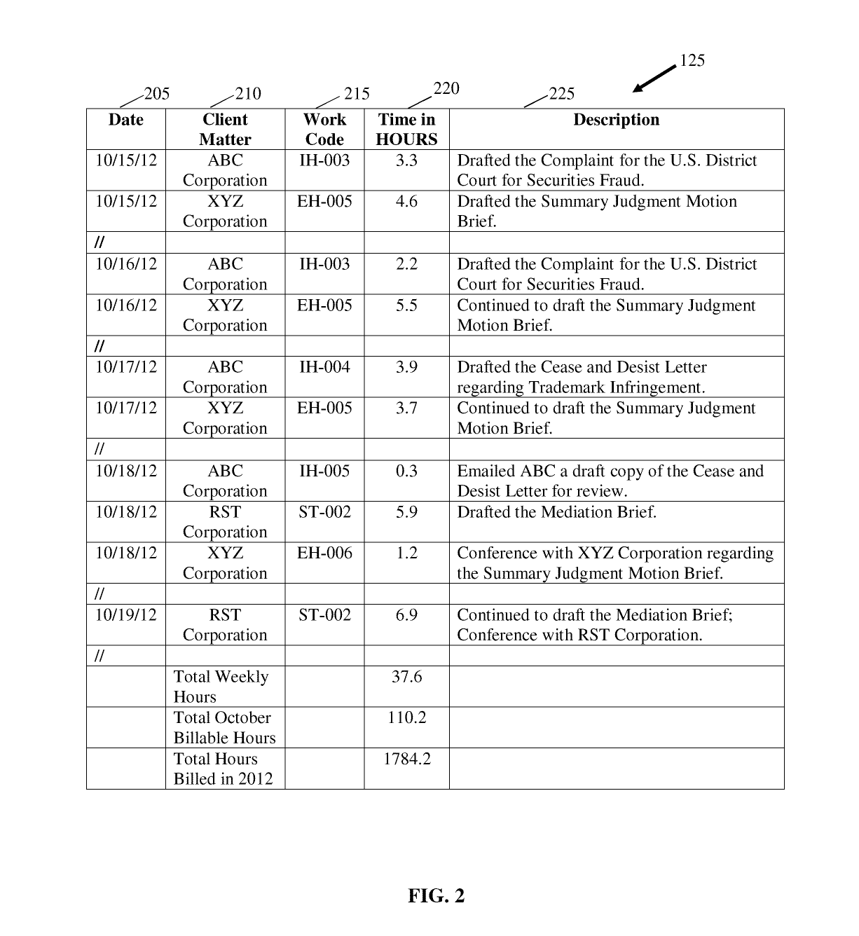

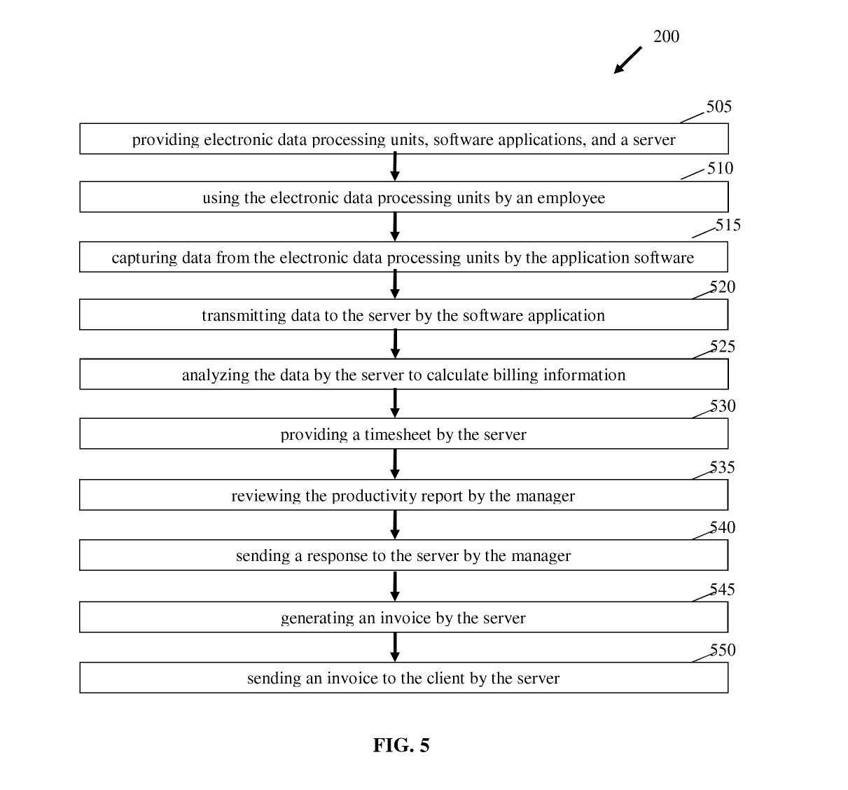

FIG. 2 is a timesheet of one embodiment of the automated billing system. As shown in FIG. 2, one embodiment of the timesheet 125 preferably includes: a date 205; client matter 210; work (or billing) code 215; time in hours 220; and description 225. The date is preferably one or more days of the month or year as specified by a number in which the employee has performed his work-related activity. The client matter 210 is preferably the identification of the respective client or subject matter in which the work-related activity addresses. The work code 215 is preferably an alpha or numeric code or a combination thereof, which identifies a specific client matter for accounting and billable purposes. The time in hours 220 preferably refers to the billable time, typically to the sixth decimal, which identifies the duration in which the employee has worked on a specific task. The automated billing system 100 will preferably identify any unrecognized time, and will use this input to improve the automated recognition. Although FIG. 5 shows the time in hours rounded to the tenth decimal place, it should be understood that the automated billing system 100 may round the task to the hundredth or thousandth decimal place, or even fractions. The description 225 is preferably one or more sentences used to describe the work-related activity performed for the specific work-related task and is usually generated by one or more computer learning algorithms. Although FIG. 5 only shows a date 205; client matter 210; work code 215; time in hours 220; and description 225, the timesheet 125 may include other billable information as well such as non-related work activities and the time spent for each non-related work activities.

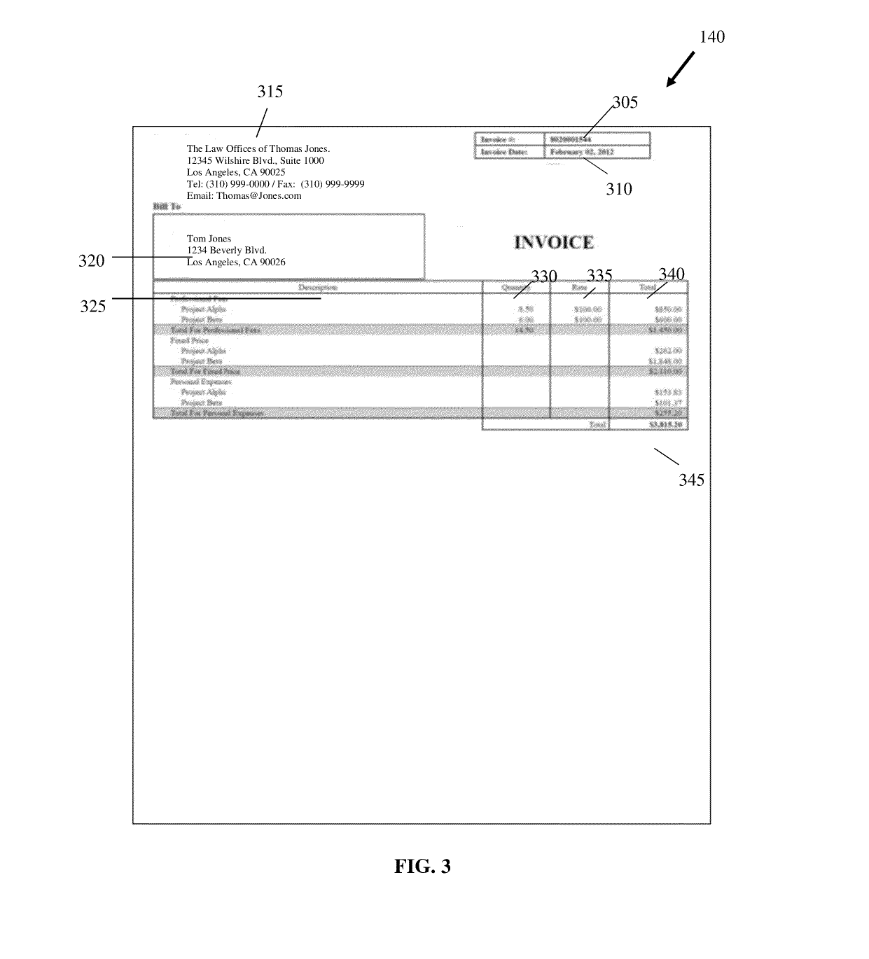

FIG. 3 is an invoice of one embodiment of the automated billing system. As shown in FIG. 3, the sample invoice 140 preferably includes: an invoice number 305; invoice date 310; biller's contact information 315; client's contact information 320; work description 325; billable hours 330; billable rate 335; sub-total charges 340; and total balance 345. The invoice number 305 is preferably a unique identification value assigned to a transaction by the company, which may be associated with a service order fulfilling and billing for one or more transactions. The invoice date 310 is preferably the date when the invoice was generated and/or mailed to the client 145. The biller's contact information 315 is preferably any contact information of the company, professional, or service provider that is rendering services to the client 145 and preferably includes the name of the company, address of the company, main telephone number, fax number, and email address. The client's contact information 320 is preferably any contact information of the person or entity that is receiving services from the biller and preferably includes the name of the client 145, address of the client 145, main telephone number, fax number, and email address. The work description 325 is preferably a brief description of the work-related activity that was rendered to the client 145. The billable hours 330 is preferably the amount of time rendered to complete each work-related activity. The billable rate 335 preferably defines the amount charged for one hour of work. The sub-total charges 340 are preferably part of a series of charges that tallies to the total balance 345. The total balance 345 is preferably the total sum amount of money due to the biller. Although FIG. 3 only shows an invoice number 305; invoice date 310; biller's contact information 315; client's contact information 320; work description 325; billable hours 330; billable rate 335; sub-total charges 340; and total balance 345, it should be understood that additional invoice information may be included such as out-of-pocket expenses. Additionally, it should be understood that the automated billing system 100 is capable of generating more than one different type of invoicing templates on-the-fly, which may be directed to specific clients. A particular invoice for a court-mandated billing report, for instance, may be sent to a bankruptcy estate.

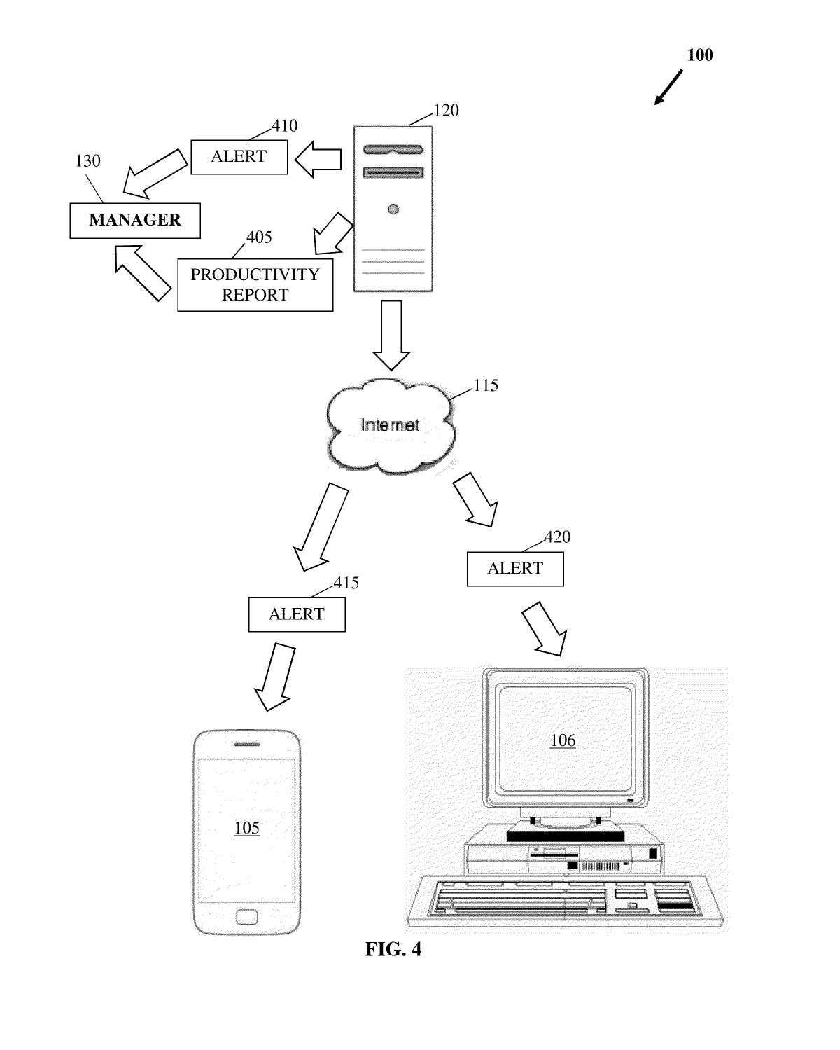

FIG. 4 is a flow chart of one embodiment of the automated billing system and shows the process of managerial reporting. As shown in FIG. 4, one embodiment of the automated billing system 100 preferably includes: one or more electronic data processing units 105, 106; Internet 115; server 120; manager 130; productivity report 405; and alerts 410, 415, 420. The productivity report 405 is preferably a report that provides information about one or more employees regarding the employee's effectiveness and profitability based upon the productivity of each work-related activity. The productivity report 405 is preferably sent by the server 120 to the manager 130 and may include graphical representations such as tables, graphs, or spreadsheets. The alerts 410, 415, 420 are preferably notifications sent from the server 120 to the manager 130 and/or employees via the electronic data processing unit 105, 106 to notify whether the employee is working on one or more improper activities such as online shopping, online gaming, internet surfing, and watching online movies.

FIG. 4 also shows the process flow of managerial reporting—i.e., the automated billing system 100 preferably sends an alert 410, 415, 420 to notify the manager and employee when an employee incorrectly bills his time. Specifically, the employee, for example, may be performing an improper activity such as online shopping for personal items and informs the system that the time was spent performing a work-related activity such as tax research. In response, the server 120 preferably sends alerts 410, 415, 420 to the manager 130 and employee, notifying the manager 130 of the improper activity. The alerts 410, 415, 420 typically include a description of the improper activity and may include a video-clip of the web-session for review by the manager 130. In other embodiments, the alerts may only be sent to either the manager or the employee, rather than both.

FIG. 5 is a block diagram of one embodiment of the computer-based method for automated billing. As shown in FIG. 5, the computer-based method 200 preferably includes the steps of: providing one or more electronic data processing units, software applications, and a server 505; using the electronic data processing units by at least one employee 510; capturing data from the electronic data processing units by the application software 515; transmitting data to the server by the software application 520; analyzing the data by the server to calculate billing information 525; providing a timesheet by the server 530; reviewing the productivity report by the manager 535; sending a response to the server by the manager 540; generating an invoice by the server 545; and sending an invoice to the client by the server 550. The first step of the computer-based method 200—providing one or more electronic data processing units, software applications, and a server 505—typically requires providing one or more computers (e.g., desktop computers, laptop computers, tablet computers, smartphones, and telephones) to at least one employee. The electronic data processing units 105, 106 are typically used for work-related activities and typically include software applications installed in the electronic data processing units 105, 106. The software applications are typically configured to capture data 110, 111 such as video stream from the display screen of the electronic data processing units 105, 106, but may also capture data 110 relating to caller activity. The server 505 is preferably configured to receive such data 110, 111 and calculate billing information based on such data 110, 111.

FIG. 5 shows the next three steps of the computer-based method 200, which are: using the electronic data processing units by at least one employee 510; capturing data from the electronic data processing units by the application software 515; and transmitting data to the server by the software application 520. Specifically, when an employee has access to the electronic data processing unit 105, 106, the employee preferably utilizes the electronic data processing unit 105, 106 for work-related activity. During this time period, the software application captures data 110, 111 from the electronic data processing units 105, 106 and transmits such data 110. 111 to the Internet 115 and ultimately to the server 120.

FIG. 5 also shows the next two steps of the computer-based method 200, which are analyzing the data by the server to calculate billing information 525 and providing a timesheet by the server 530. Specifically, once the server 120 receives data 110, 111 from the electronic data processing units 105, 106, the server 120 analyzes the data 110, 111 to determine billing information such as the type of tasks that each employee was working on and the amount of time spent on each tasks. The server 120 typically analyzes the data 110, 111 by utilizing machine learning algorithms, text recognition methods, computer vision algorithms, or a combination thereof. The server 120 may also perform other functions as well such as sending an alert 510, 515, 520 if the employee is performing any improper activities (e.g., online shopping, online surfing, online gaming, video media) or sending out a productivity report 505. The server 120 may also verify whether the activities performed on the electronic data processing units 105, 106 are work-related by reviewing an engagement letter by the clients. After analyzing the data 110, 111, the server 120 generates a timesheet 125 that is based upon billing information such as a client matter, work code, and/or description of the work-related activity. The timesheet 125 is usually sent out to the manager 130 or appropriate personal for review.

The next two steps of the computer-based method 200 is reviewing the productivity report by the manager 535 and sending a response to the server by the manager 540. Specifically, once the manager 130 receives the timesheet 125, the manager 130 may review, comment, or edit the timesheet 125. When editing the timesheet 125, the manager 130, for instance, may approve a bill, hold a bill, apply a discount, write off a task, edit individual time entries, write a specific time, adjust descriptions, change an invoice template, and make other changes as needed. This typically requires the manager 130 to send a response 135 to the server 120 such as an approval, edits, comments, or the like, which may be performed online These two steps may also be assigned to another manager as well.

Finally, the last two steps of the computer-based method 200 is generating an invoice by the server 545 and sending an invoice to the client by the server 550. Specifically, once the server 120 receives the response 135 from the manager 130, the server 120 preferably generates an invoice 140, which will be sent to the appropriate client for payment. The invoice may be sent electronically via email or physically by air postal mail. The electronic invoices will preferably include “pay now” options, which will encourage immediate payment through credit or debit cards. The physical letters, on the other hand, may be sent through a customized letter and envelope, and may include a customized uniform resource locator (URL) to provide an online immediate payment option. Although FIG. 5 shows an invoice being sent by the server to the client, it should be understood that the present invention also allows the manager 130 to directly send the invoice to the client 145 rather than the server 120.

Where emails are generated and not open within several days, the automated billing system 100 may make additional attempts at emailing. Should the message not be opened, a physical letter containing the invoice may be automatically delivered to the client with an optional message notifying the client that the email address did not successfully deliver the email. If the client 145, on the other hand, fails to make a payment, the automated billing system 100 may notify the service provider.

Although FIG. 5 shows the steps being performed in a certain order, it should be understood that the steps may be performed in other orders without deviating from the scope of the invention.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. An automated billing system, the system comprising:
one or more electronic data processing units;
one or more software applications; and
a server;
wherein said one or more electronic data processing units are configured for one or more work-related activities and are used by at least one employee;
wherein said one or more software applications are installed in said one or more electronic data processing units and are configured to capture a plurality of data from said one or more electronic data processing units;
wherein said one or more software applications transmits said plurality of data to said server;
wherein said server analyzes said plurality of data to calculate a plurality of billing information;
wherein said server generates a timesheet; and
wherein said timesheet is based upon said plurality of billing information.

2. The automated billing system of claim 1, wherein said one or more electronic data processing units are comprised of one or more display screens;
wherein said plurality of data is a plurality of screen data from said one or more display screens of said one or more electronic data processing units.

3. The automated billing system of claim 2, wherein said server analyzes said plurality of data by utilizing one or more machine learning algorithms, one or more text recognition methods, and one or more computer vision algorithms.

4. The automated billing system of claim 3, wherein said plurality of billing information is selected from the group of information consisting of: a client matter;
a work code; and a description of said one or more work-related activities.

5. The automated billing system of claim 4, wherein said server is configured to provide:
an alert; and
a productivity report;
wherein said alert is sent to a manager and said at least one employee when said at least one employee performs one or more improper activities; and
wherein said productivity report is a graphical representation of a work performance of said at least one employee.

6. The automated billing system of claim 5, wherein said server provides one or more invoicing templates based upon said timesheet.

7. The automated billing system of claim 6, wherein said server automatically sends one or more invoices to one or more clients.

8. The automated billing system of claim 7, wherein said server verifies said one or more work-related activities when said server analyzes an engagement letter of said one or more clients.

9. The automated billing system of claim 1, wherein said one or more electronic data processing units are one or more mobile phones, such that said plurality of data is one or more caller information; and
wherein said one or more caller information is comprised of: one or more telephone numbers; one or more time stamps; and a time period.

10. The automated billing system of claim 9, wherein said one or more mobile phones are comprised of one or more display screens;
wherein said plurality of data is a plurality of screen data from said one or more display screens of said one or more mobile phones.

11. A computer-based method for automated billing, the method comprising:
providing one or more electronic data processing units;
providing one or more software applications;
providing a server;
wherein said one or more electronic data processing units are configured for one or more work-related activities;
wherein said one or more software applications are installed in said one or more electronic data processing units and are configured to capture a plurality of data from said one or more electronic data processing units;
using said one or more electronic data processing units by at least one employee to perform said one or more work-related activities, such that said plurality of data is generated;
capturing said generated plurality of data from said one or more electronic data processing units by said one or more software applications;
transmitting said plurality of generated and captured data to said server by said one or more software applications;
analyzing said plurality of generated, captured, and transmitted data by said server to calculate one or more billing information; and
providing a timesheet by said server;
wherein said timesheet is based upon said one or more billing information.

12. The computer-based method for automated billing of claim 11, wherein said one or more electronic data processing units are comprised of a one or more display screens;
wherein said plurality of data is a plurality of display screen data of said one or more electronic data processing units.

13. The computer-based method for automated billing of claim 12, wherein said analyzing by said server is performed by said server via one or more machine learning algorithms, one or more text recognition methods, and one or more computer vision algorithms.

14. The computer-based method for automated billing of claim 13, wherein said one or more billing information is selected from the group of information consisting of:
a client matter; a work code; and a description of said one or more work-related activities.

15. The computer-based method for automated billing of claim 14, further comprising the steps of:
issuing an alert by said server; and
issuing a productivity report by said server;
wherein said alert is sent to a manager and said at least one employee when said at least one employee performs one or more improper activities; and
wherein said productivity report is a graphical representation of a work performance of said at least one employee.

16. The computer-based method for automated billing of claim 15, further comprising the step of:
providing by said server one or more invoicing templates for said timesheet.

17. The computer-based method for automated billing of claim 16, further comprising the step of:
sending by said server one or more invoices to one or more clients.

18. The computer-based method for automated billing of claim 17, further comprising the step of:
verifying by said server said one or more work-related activities when said server analyzes an engagement letter of said one or more clients.

19. The computer-based method for automated billing of claim 11, wherein said one or more electronic data processing units are one or more mobile phones, such that said plurality of data is one or more caller information;
wherein said one or more caller information is comprised of: one or more telephone numbers; one or more time stamps; and a time period; and
wherein said plurality of data is comprised of a display screen activity of said one or more mobile phones.

20. The computer-based method for automated billing of claim 11, wherein said one or more work-related activities are related to drafting an email; wherein said server summarizes said email.
